(19) United States
(12) Patent Application Publication
(10) Pub. No.: US 2013/0318628 A1
(43) Pub. Date: Nov. 28, 2013

(54) Systems and Methods for Providing Access to Computer Programs Based on Physical Activity Level of a User

(71) Applicant: Gregory A. Dunko, Cary, NC (US)

(72) Inventor: Gregory A. Dunko, Cary, NC (US)

(73) Assignee: HTC CORPORATION, Taoyuan City (TW)

(21) Appl. No.: 13/481,349

(22) Filed: May 25, 2012

(51) Int. Cl. G06F 21/00

(52) U.S. Cl. 726/28

(57) ABSTRACT

Systems and methods for providing access to computer programs based on physical activity level of a user are provided. In this regard, a representative system includes: a mobile device having a movement monitoring system operative to monitor movement of the mobile device; and a threshold detection system communicating with the movement monitoring system and operative to provide access information to enable use of the computer program, use of which is otherwise disabled, the access information being provided responsive to the monitored movement of the mobile device corresponding to a threshold level of activity of a user of the mobile device.

### TECHNICAL FIELD

The present disclosure generally relates to mobile devices.

### BACKGROUND

Access to computer programs is often difficult to restrict in a meaningful manner, such as when a parent is attempting to restrict access to a computer program by a child. For instance, various forms of parental controls are available that prevent access until an access code is input. However, if the parent is not available to input the access code, the child may be unable to access the computer program.

### SUMMARY

Systems and methods for providing access to computer programs based on physical activity level of a user are provided. Briefly described, one embodiment, among others, is a system comprising: a mobile device having a movement monitoring system operative to monitor movement of the mobile device; and a threshold detection system communicating with the movement monitoring system and operative to provide access information to enable use of the computer program, use of which is otherwise disabled, the access information being provided responsive to the monitored movement of the mobile device corresponding to a threshold level of activity of a user of the mobile device.

Another embodiment is a method comprising: monitoring movement of a mobile device; and enabling use of the computer program based, at least in part, on monitored movement of the mobile device such that, responsive to the monitored movement corresponding to a threshold level of activity of a user of the mobile device, the computer program is enabled.

Other systems, methods, features, and/or advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a system for providing access to computer programs based on physical activity level of a user.

FIG. 2 is a flowchart depicting an example embodiment of a method for providing access to computer programs based on physical activity level of a user.

FIG. 3 is a schematic diagram of an example embodiment of a mobile device.

FIG. 4 is a flowchart depicting functionality that may be performed by an example embodiment of a mobile device, such as the mobile device of FIG. 3.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, systems and methods for providing access to computer programs based on physical activity level of a user are provided, some embodiments of which involve the use of mobile devices that provide access information for enabling the computer programs (i.e., permitting users to interact with the programs), which are otherwise disabled. By way of example, movements of a user of a mobile device may be monitored by onboard components and, responsive to the monitored movement corresponding to a threshold level of activity, the mobile device may facilitate access to a computer program (e.g., a gaming program that is resident on an electronic device). In some embodiments, the access may be facilitated by an access code that is displayed to the user via the mobile device, and which may be input to the device upon which the computer program resides. In this manner, physical activity of the user may be promoted as access to one or more programs may be provided as a form of reward for performing a threshold level of physical activity.

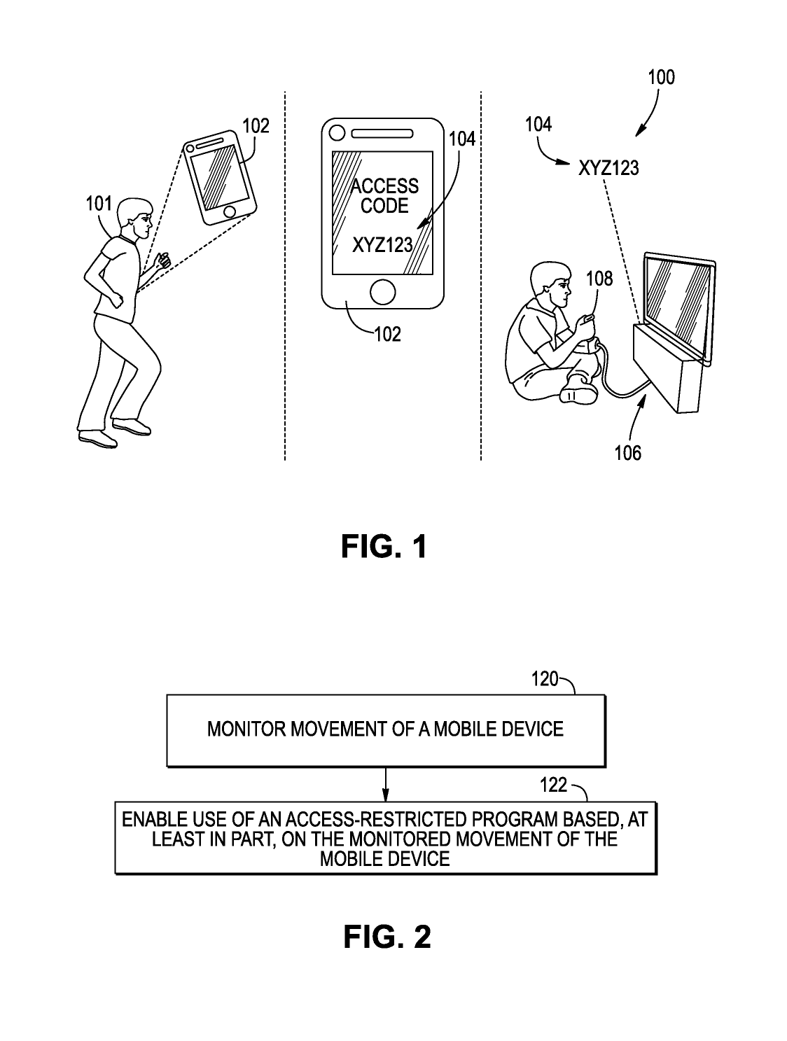

FIG. 1 is a schematic diagram of an example embodiment of a system for providing access to computer programs based on physical activity level of a user. As shown in FIG. 1, system 100 depicts a user 101 with a mobile device 102. In the leftmost frame, the user is shown exercising. While this is taking place, the mobile device monitors movement of the user to acquire movement information corresponding to the level of physical activity performed by the user (the assumption being that the mobile device is being carried by the user). In some embodiments, the level of physical activity is based only on the sensed movements of the mobile device. Additionally or alternatively, location information associated with distance traveled by a user may be used.

Responsive to determining that a threshold level of physical activity has been performed by the user, access information 104 (depicted in the center frame of FIG. 1) is provided to the user via the mobile device. In this embodiment, the access information is provided as an access code that the user manually enters into an input device. For instance, as shown in the rightmost frame of FIG. 1, the user may provide the access code to electronic device 106 via an input device 108 so that one or more access-restricted computer programs associated with the electronic device may be accessed. It should be noted that electronic device 106 may be provided in various configurations, such as a laptop or gaming system, for example. In this context, “access-restricted” refers to a manner of preventing use of a program, such as but not limited to blocking launching of the program, preventing access to a screen that facilitates program start, disabling a computer or gaming system, disabling internet access, disabling a specific application. Additionally, “rewards” may be earned in some embodiments for activity (e.g., more\better weaponry to be used in an application, among others).

Regardless of the particular manner in which access is restricted, access to the program is selectively provided by the access information. Notably, further access to the program after elapse of a predetermined time interval of use may be prevented until other access information is provided.

In an example of operation depicted in FIG. 1, assume that a parent of user 101 would like to ensure that their child is getting enough exercise. The parent ensures that the child carries mobile device 102, which acquires movement information associated with the child. Responsive to the movement information corresponding to a threshold amount of physical activity (which may be aggregated over a period of time), access information 104 may be provided to the child via the mobile device. In this case, the access information is an access code, which the child may use for enabling a program associated with electronic device 106 (e.g., a video gaming device). After a predetermined time of use has elapsed, access to the program is restricted once again. The process may then be repeated, thereby ensuring that physical activity takes place prior to access being provided to the program.

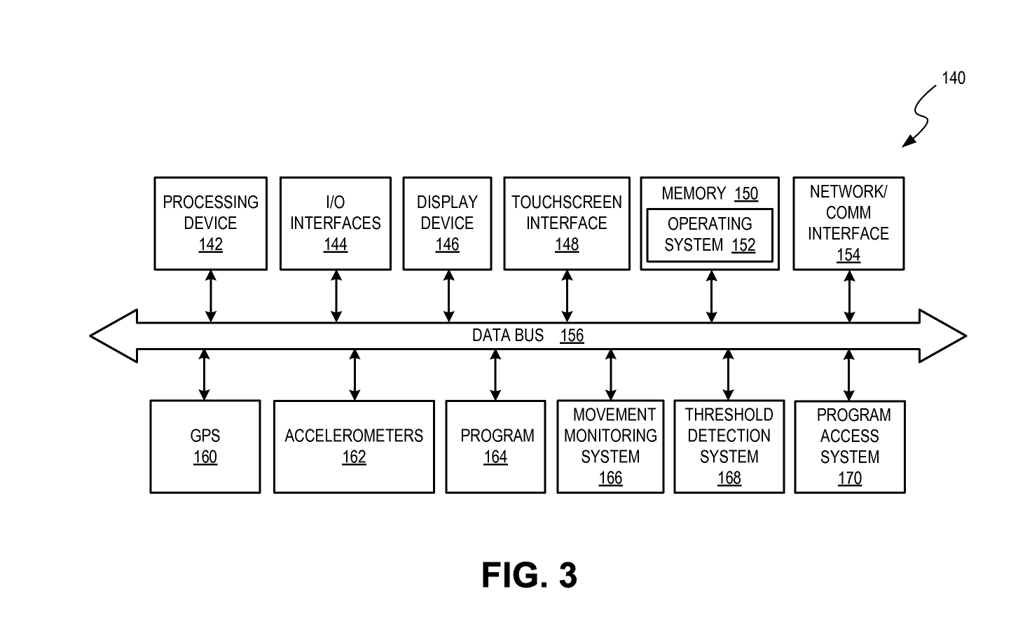

FIG. 2 is a flowchart depicting an example embodiment of a method for providing access to computer programs based on physical activity level of a user, such as may be performed by the system of FIG. 1. As shown in FIG. 2, the method involves monitoring movement of a mobile device (block 120). In block 122, the method includes enabling use of the computer program based, at least in part, on monitored movement of the mobile device such that, responsive to the monitored movement corresponding to a threshold level of activity of a user of the mobile device, the computer program is enabled.

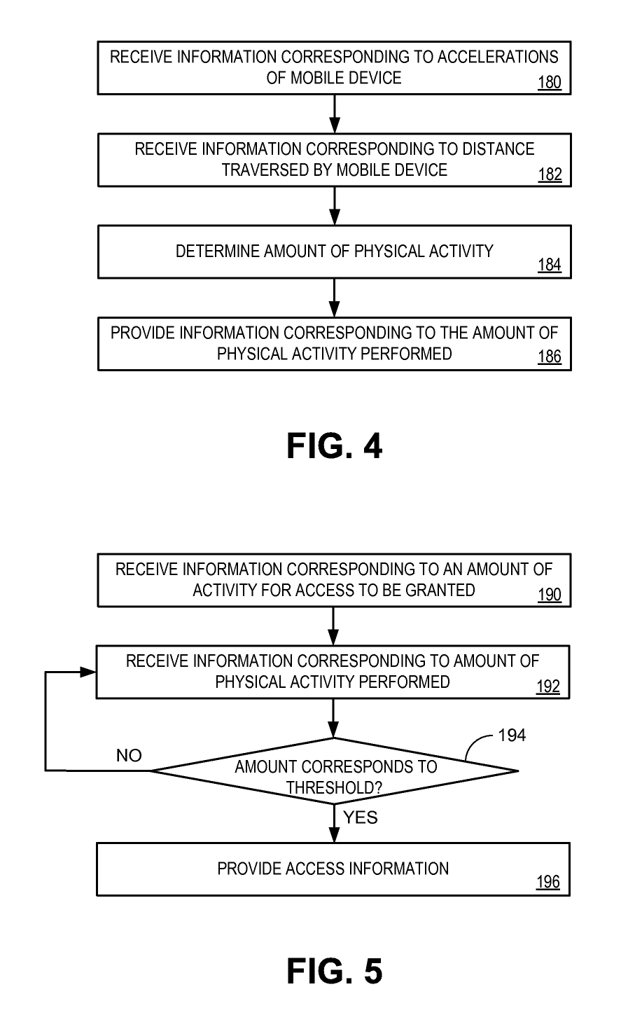

FIG. 3 is a schematic diagram of an example embodiment of a mobile device. As shown in FIG. 3, mobile device 140 includes a processing device (processor) 142, input/output interfaces 144, a display device 146, a touchscreen interface 148, a memory 150, operating system 152, and a network/communication interface 154, with each communicating across a local data bus 156. Additionally, the system incorporates a position/location determination capability (which in this case is implemented as a global positioning system (GPS) 160), a motion sensing capability (which is implemented in this case as one or more accelerometers 162), an access-restricted program 164, a movement monitoring system 166, a threshold detection system 168 and a program access system 170.

The processing device 142 may include a custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 150 may include any one of a combination of volatile memory elements (e.g., random-access memory (RAM, such as DRAM, and SRAM, etc.)) and nonvolatile memory elements. The memory typically comprises native operating system 152, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device. Note that although depicted as being stored separately from memory 150, one or more of the depicted systems may be resident in the memory.

Touchscreen interface 148 may be configured to detect contact within the display area of the display 146 and provides such functionality as on-screen buttons, menus, keyboards, soft keys, etc. that allows users to navigate user interfaces by touch.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 3, network/communication interface device 154 comprises various components used to transmit and/or receive data over a networked environment. By way of example, such components may include a wireless communications interface. When such components are embodied as an application, the one or more components may be stored on a non-transitory computer-readable medium and executed by the processing device.

GPS 160 is configured to determine a current location of the mobile device and may communicate location information for use by one or more of various systems, such as movement monitoring system 166. Additionally, the one or more accelerometers 162 are configured to sense movement of the mobile device and may communicate acceleration information for use by one or more of various systems, such as movement monitoring system 166.

In operation, the movement monitoring system receives information that corresponds to the level of physical activity of a user of the mobile device. As mentioned before, this may include receiving information corresponding to acceleration of the mobile device and/or location information that may be used to determine distance traveled by the mobile device. Note that the acceleration\motion signatures may be used to identify a given activity.

Responsive to the received information, the movement monitoring system may determine a level of physical activity, such as an aggregate amount of activity performed between designated start and end times. Notably, in some embodiments, start and/or end times may be designated by a user. Additionally or alternatively, a start time may be triggered by a threshold level of activity being sensed, for example.

Threshold detection system 168 receives information corresponding to the monitored level of physical activity and determines whether the monitored level corresponds to an established threshold. In this embodiment, the information is provided by the movement monitoring system. By way of example, the threshold may correspond to a predefined amount of physical activity to be performed. Responsive to determining that the predefined amount of physical activity has been performed, the threshold detection system provides access information, which may be used for enabling access of an access-restricted program.

Program access system 170 provides the functionality for selectively restricting and providing access to an access-restricted program (e.g., program 164). In this embodiment, the program access system responds to input of the access information by enabling program 164. Notably, in this embodiment, the access provided responsive to entering of the access information is for a predetermined period of time, after which access is once again restricted.

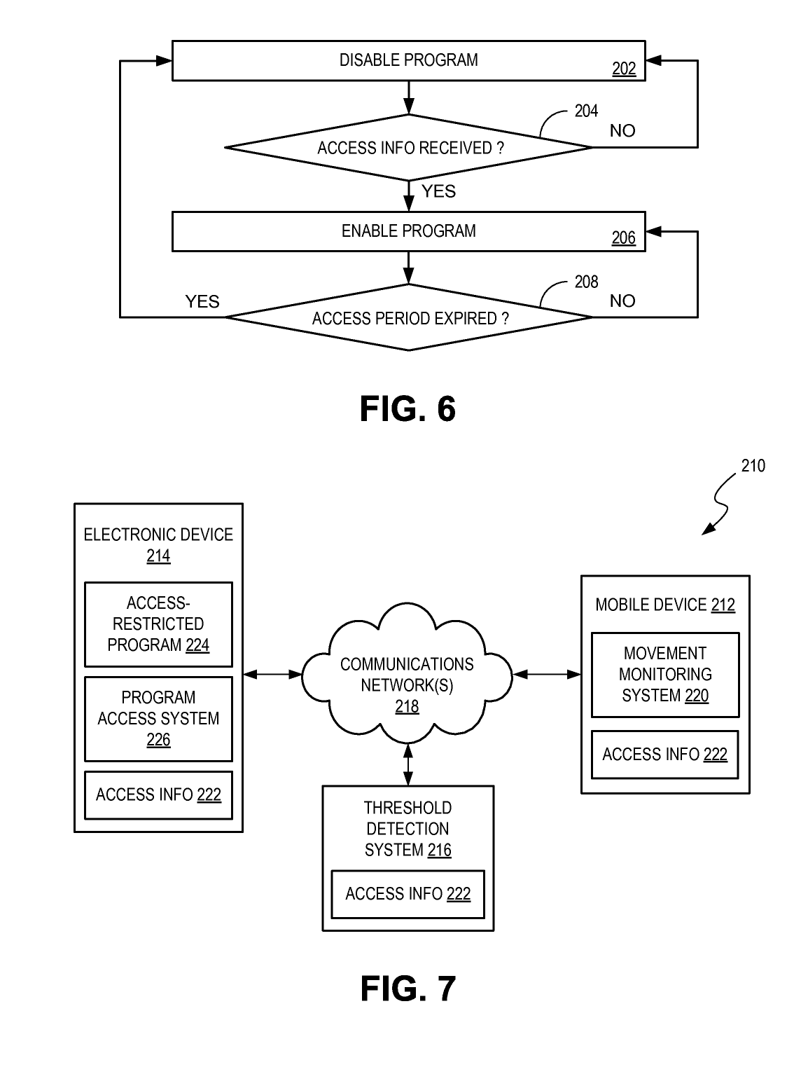

FIG. 4 is a flowchart depicting functionality that may be performed by an example embodiment of a movement monitoring system, such as movement monitoring system 166. As shown in FIG. 4, the functionality (or method) may be construed as beginning at block 180, in which information corresponding to accelerations sensed by the mobile device is received. In block 182, information corresponding to a distance traversed by the mobile device is received. Then, in block 184, an amount of physical activity performed is determined based, at least in part, on the information received. In block 186, information corresponding to the amount of physical activity is provided, such as to a threshold detection system.

FIG. 5 is a flowchart depicting functionality that may be performed by an example embodiment of a threshold detection system, such as threshold detection system 168. As shown in FIG. 5, the functionality (or method) may be construed as beginning at block 190, in which information corresponding to an amount of physical activity for which access to a program is to be granted is received. By way of example, referring to the parental control scenario previously described, the information may be provided by a parent to the threshold detection system to indicate that access may be granted after 300 calories are burned within a 30 minute period. In block 192, information corresponding to the amount of physical activity performed is received. Then, in block 194, a determination is made as to whether the amount of physical activity performed corresponds to the threshold amount for granting access. If it is determined that the amount of physical activity performed is adequate, the process may proceed to block 196, in which access information is provided to the user of the mobile device. However, if the amount of physical activity is not adequate, the process may return to block 192.

FIG. 6 is a flowchart depicting functionality that may be performed by an example embodiment of a program access system, such as program access system 170. As shown in FIG. 6, the functionality (or method) may be construed as beginning at block 202, in which the program is disabled. As mentioned before, this may be accomplished in various manners to restrict use of the program by the user. In block 204, a determination is made as to whether access information has been received. If access information has been received the process may proceed to block 206, in which an access-restricted program is enabled so that a user may use the program. However, if access information has not been received, the process may return to block 202. After enabling of the program in block 206, the process may proceed to block 208, in which a determination is made as to whether an access period associated with enabling of the program has expired. If the access period has not expired the process may return to block 206. However, if the access period has expired, the process may return to block 202, in which the program is disabled.

If embodied in software, it should be noted that each block depicted in the flowchart of FIG. 4 (or any of the other flowcharts) may represent a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

FIG. 7 is a schematic diagram of another example embodiment of a system for providing access to computer programs based on physical activity level of a user. In particular, this embodiment involves a distributed architecture in which various systems are resident on different devices.

As shown in FIG. 7, system 210 includes a mobile device 212, an electronic device 214 and a threshold detection system 216 that communicate via communications network 218. It should be noted that the communications network may include one or more wired and/or wireless networks that are associated with one or more communication protocols.

Mobile device 212 incorporates a movement monitoring system 220 that monitors movement of the mobile device. This is done to acquire movement information corresponding to the level of physical activity performed by the user (the assumption being that the mobile device is being carried by the user). In some embodiments, the movement monitoring system may determine the level of physical activity based on the sensed movements of the mobile device. In other embodiments, the movement monitoring system may facilitate communication of information, such as location information and acceleration information associated with the mobile device, to another system (e.g., threshold detection system 216), which may then determine the level of physical activity.

It should be noted that when location information is being used to determine a distance traveled by the user, the user also may be prompted to input information corresponding to a manner of travel, such as walking or biking, which may influence the determination of the level of physical activity. In other embodiments, more sophisticated algorithms may be used that may involve the use of motion signatures for determining various aspects of sensed movements. For instance, motion activity of the mobile device (i.e., movements of the device about various axes while remaining in generally the same location, as may be revealed by acceleration information) may be used to determine an intensity level of user activity and/or may be used to predict a manner of travel or type of exercise.

In the embodiment of FIG. 7, the movement monitoring system determines the level of physical activity of the user of the mobile device and then communicates movement information corresponding to the level of physical activity to access system 216. The threshold detection system determines whether the amount of physical activity communicated by the movement information corresponds to a threshold level of activity, which may be set by a parent, for example. Responsive to such a determination, the threshold detection system provides access information 222 to the mobile device that may enable use of one or more computer programs.

In other embodiments, the functionality associated with the threshold detection system may be provided onboard the mobile device. In such an embodiment, functionality onboard the mobile device determines whether the user has been physically active enough to be able to use a computer program. If so, the mobile device may produce and then provide the access information to the user.

Electronic device 214 of FIG. 7 (which may be provided in various configurations, such as a laptop or gaming system, for example) includes an access-restricted computer program 224. Regardless of the particular manner in which access is restricted, access to the program is selectively provided by program access system 226. Specifically, the program access system is operative to enable program 224 responsive to receiving access information 222. Notably, this may involve disabling further access to the program after a predetermined time interval of use of the program has elapsed.

In an example of operation, assume the case of a parent who would like to ensure that their child is getting enough exercise. The parent ensures that the child carries mobile device 212, which acquires movement information associated with the child. Responsive to the movement information corresponding to a threshold aggregate amount of physical activity, access information 222 may be provided to the child via the mobile device. In this case, the access information is an access code, which the child may user for enabling access of program 226, which is loaded into electronic device 214 (e.g., a video gaming device). After a predetermined time of use has elapsed, access to the program is restricted once again. The process may then be repeated thereby ensuring physical activity takes place prior to access being provided to the program. It should be noted that, in this embodiment, access system 216 provides functionality that enables the parent to set the threshold of physical activity and the duration of use of the program.

It should be emphasized that the above-described embodiments are merely examples of possible implementations. Many variations and modifications may be made to the above-described embodiments without departing from the principles of the present disclosure. By way of example, the systems described may be implemented in hardware (e.g., logic), software or combinations thereof. All such modifications and variations are intended to be included herein within the scope of this disclosure and protected by the following claims.

At least the following is claimed:

1. A method for providing access to computer programs based on physical activity level of a user comprising:
monitoring movement of a mobile device; and
enabling use of the computer program based, at least in part, on monitored movement of the mobile device such that, responsive to the monitored movement corresponding to a threshold level of activity of a user of the mobile device, the computer program is enabled.

2. The method of claim 1, wherein enabling use of the computer program further comprises providing access information responsive to the monitored movement of the mobile device corresponding to predefined movement parameters, the access information being operative to enable use of the computer program.

3. The method of claim 2, wherein, in enabling use of the computer program, the access information enables use for a predetermined duration.

4. The method of claim 3, wherein:
the method further comprises determining an amount of activity performed by a user of the mobile device; and
in enabling use of the computer program, the access information enables use for a duration corresponding to the amount of work performed.

5. The method of claim 2, wherein the computer program is resident on an electronic device other than the mobile device.

6. The method of claim 5, wherein:
the access information is provided as an access code provided to a user via the mobile device; and
enabling use of the computer program further comprises receiving the access code entered by the user.

7. The method of claim 5, further comprising communicating the access information from the mobile device to the electronic device such that use of the computer program is enabled.

8. The system of claim 1, wherein the computer program is resident on the mobile device.

9. The method of claim 1, wherein monitoring movement comprises monitoring an intensity of movement of the mobile device.

10. The method of claim 1, wherein monitoring movement comprises monitoring a distance traveled by the mobile device.

11. The method of claim 1, further comprising enabling a reward feature of the program responsive to the monitored movement of the mobile device corresponding to the predefined movement parameters.

12. A system for providing access to computer programs based on physical activity level of a user comprising:
a mobile device having a movement monitoring system operative to monitor movement of the mobile device; and
a threshold detection system communicating with the movement monitoring system and operative to provide access information to enable use of the computer program, use of which is otherwise disabled, the access information being provided responsive to the monitored movement of the mobile device corresponding to a threshold level of activity of a user of the mobile device.

13. The system of claim 12, wherein the access system is resident on the mobile device.

14. The system of claim 12, wherein the computer program is resident on the mobile device.

15. The system of claim 12, wherein:
the system further comprises an electronic device; and
the computer program is resident on the electronic device.

16. The system of claim 15, wherein:
the electronic device further comprises a program access system; and
the program access system is operative to enable use of the computer program responsive to receiving the access information.

17. The system of claim 16, wherein the program access system is further operative to receive information corresponding to computer programs resident on the electronic device for which access is to be restricted unless associated access information is provided.

18. The system of claim 16, wherein the program access system is further operative to disable use of the computer program after a predetermined duration.

19. The system of claim 12, wherein the mobile device has an accelerometer operative to detect an acceleration of the mobile device and to communicate acceleration information, corresponding to detected accelerations, to the movement monitoring system.

20. The system of claim 19, wherein the mobile device has onboard GPS operative to determine a current location of the mobile device and to communicate location information, corresponding to the current location, to the movement monitoring system.

21. A computer-readable medium containing instructions for performing a method for providing access to computer programs based on physical activity level of a user comprising:
monitoring movement of a mobile device; and
enabling use of the computer program based, at least in part, on monitored movement of the mobile device such that, responsive to the monitored movement corresponding to a threshold level of activity of a user of the mobile device, the computer program is enabled.
